(19) United States
(12) Patent Application Publication
(10) Pub. No.: US 2024/0138376 A1
(43) Pub. Date: May 2, 2024

(54) ANTI-PULLING ANIMAL HARNESS

(71) Applicant: Kimberly Kilborn, Kula, HI (US)

(72) Inventor: Kimberly Kilborn, Kula, HI (US)

(21) Appl. No.: 17/979,628

(22) Filed: Nov. 2, 2022

(51) Int. Cl. A01K 27/00

(52) U.S. Cl. CPC A01K 27/002

(57) ABSTRACT

An anti-pulling animal harness, including a main body to be worn on a body of an animal, a leg wrap connected to the main body to be worn on front legs of the animal, and a plurality of leashes connected to the main body and the leg wrap to control movement of the leg wrap.

### BACKGROUND

### 1. Field

The present general inventive concept relates generally to an animal harness, and particularly, to an anti-pulling animal harness.

### 2. Description of the Related Art

Taking an animal, such as a dog, for a walk is an important means of care for the animal. The animal is able to engage in physical exercise during the walk as well as explore an outdoor environment and engage in socialization in a setting beyond a home environment.

In most cases, an owner and/or an animal walker will use a leash to walk the animal. During the walk, many dogs will attempt to pull on the leash to get where they are going and/or in response to stimuli which can be challenging for the owner and/or the animal walker to control. Additionally, when dogs pull, the owner and/or the animal walker may often find it difficult to manage the dog which can be frustrating and potentially dangerous, especially, if the dog overpowers the owner and/or the walker.

Therefore, there is a need for an anti-pulling animal harness that is worn by the animal and prevents the animal from pulling.

### SUMMARY

The present general inventive concept provides an anti-pulling animal harness.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an anti-pulling animal harness, including a main body to be worn on a body of an animal, a leg wrap connected to the main body to be worn on front legs of the animal, and a plurality of leashes connected to the main body and the leg wrap to control movement of the leg wrap.

The leg wrap may include a plurality of wrap bodies to receive the front legs of the animal therethrough, and a plurality of leg leash connectors disposed on at least a portion of at least one of the plurality of wrap bodies to connect to at least one of the plurality of leashes.

The anti-pulling animal harness may further include a plurality of body leash connectors disposed on at least a portion of the main body to receive at least one of the plurality of leashes therethrough.

The plurality of body leash connectors dispose the plurality of leashes against the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a first side perspective view of an anti-pulling animal harness, according to an exemplary embodiment of the present general inventive concept; and

FIG. 2 illustrates a second side perspective view of the anti-pulling animal harness, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Anti-Pulling Animal Harness 100
Main Body 110
Leg Wrap 120
Wrap Bodies 121
Leg Leash Connectors 122
Leashes 130
First Leash 131
Second Leash 132
Body Leash Connectors 140
Handle 150

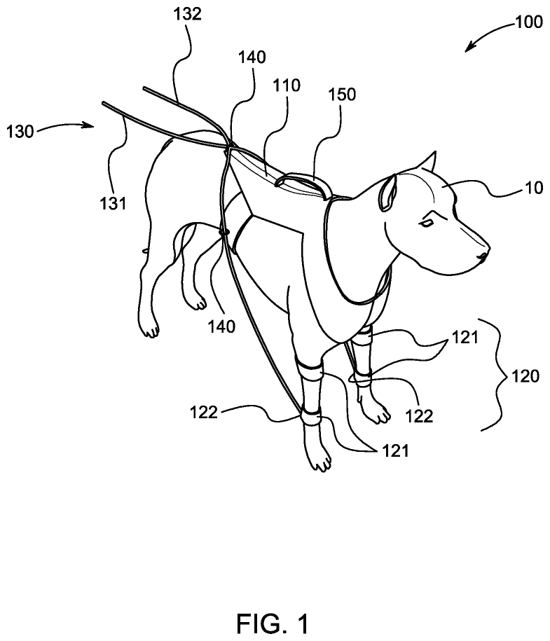

FIG. 1 illustrates a first side perspective view of an anti-pulling animal harness 100, according to an exemplary embodiment of the present general inventive concept.

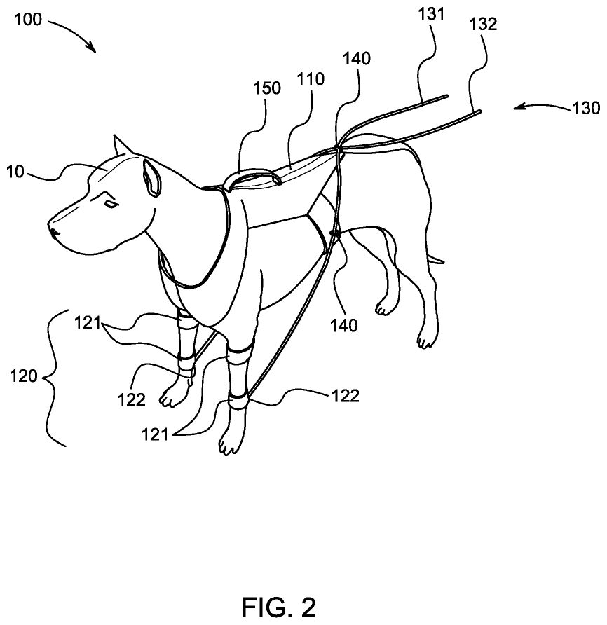

FIG. 2 illustrates a second side perspective view of the anti-pulling animal harness 100, according to an exemplary embodiment of the present general inventive concept.

The anti-pulling animal harness 100 may be constructed from at least one of metal, plastic, wood, and rubber, etc., but is not limited thereto.

The anti-pulling animal harness 100 may include a main body 110, a leg wrap 120, a plurality of leashes 130, a plurality of body leash connectors 140, and a handle 150, but is not limited thereto.

The main body 110 may have a predetermined size based on a size of an animal 10. For example, the main body 110 may be constructed to have a size corresponding to a size of a dog, a cat, a ferret, and/or any other type of animal. In other words, the main body 110 may vary in size. Alternatively, the main body 110 may be elastic, such that the main body 110 may at least partially deform (e.g., bend, stretch, expand) in response to being worn. As such, the main body 110 may be a one size fits all.

The main body 110 may be removably disposed on at least a portion of a body of the animal 10. Therefore, the main body 110 may be worn by the animal 10.

The leg wrap 120 may include a plurality of wrap bodies 121 and a plurality of leg leash connectors 122, but is not limited thereto.

Referring to FIGS. 1 and 2, the plurality of wrap bodies 121 are illustrated to be separate from the main body 110. However, the plurality of wrap bodies 121 may be disposed on and/or connected to at least a portion of the main body 110 via a cord disposed therebetween.

Each of the plurality of wrap bodies 121 may form a loop. Moreover, each of the plurality of wrap bodies 121 may be removably disposed on at least a portion of a front leg of the animal 10. Therefore, each of the plurality of wrap bodies 121 may receive (i.e., be worn on) the front legs of the animal 10 therethrough.

Each of the plurality of leg leash connectors 122 may include a hook, a loop, a strap, a clamp, a clasp, a clip, a hook-and-loop fastener, an adhesive (e.g., tape, glue), a magnet, and/or any combination thereof, but is not limited thereto.

Each of the plurality of leg leash connectors 122 may be disposed on at least a portion of at least one of the plurality of wrap bodies 121.

The plurality of leashes 130 may include a first leash 131 and a second leash 132, but is not limited thereto.

The first leash 131 and/or the second leash 132 may include a cord, a string, a rope, and a twine, but is not limited thereto. Also, the first leash 131 and/or the second leash 132 may be elastic. As such, the first leash 131 and/or the second leash 132 may at least partially deform (e.g., bend, stretch, expand) in response to an application of force thereto (e.g., pushing, pulling).

The first leash 131 and/or the second leash 132 may be removably connected to the main body 110 and/or at least one of the plurality of leg leash connectors 122. For example, the first leash 131 and/or the second leash 132 may be connected (e.g., tied, wrapped around, looped through) to the main body 110 and/or at least one of the plurality of leg leash connectors 122. In other words, each of the plurality of leg leash connectors 122 may receive the first leash 131 and/or the second leash 132 therethrough.

As such, the first leash 131 and/or the second leash 132 may be connected to the front legs of the animal 10, such that the first leash 131 and/or the second leash 132 may control movement of the plurality of wrap bodies 121 by preventing pulling by the animal 10 due to leverage on the front legs being connected to the first leash 131 and/or the second leash 132. Also, the animal 10 may fall and/or trip easily by attempting to pull on the first leash 131 and/or the second leash 132 while connected to at least one of the plurality of leg leash connectors 122.

Each of the body leash connectors 140 may include a hook, a loop, a strap, a clamp, a clasp, a clip, a hook-and-loop fastener, an adhesive (e.g., tape, glue), a magnet, and/or any combination thereof, but is not limited thereto.

Each of the plurality of body leash connectors 140 may be disposed on at least a portion of the main body 110. For example, a first of the plurality of body leash connectors 140 may be disposed on a first (e.g., right) side of the main body 110, a second of the plurality of body leash connectors 140 may be disposed on a second (e.g., left) side of the main body 110, and a third of the plurality of body leash connectors 140 may be disposed on a third side (e.g., top) of the main body 110. Each of the plurality of body leash connectors 140 may receive the first leash 131 and/or the second leash 132 therethrough. Thus, the plurality of body leash connectors 140 may connect the first leash 131 and/or the second leash 132 to the main body 110. Also, the plurality of body leash connectors 140 may stabilize control of the animal 10 due to receiving the plurality of leashes 130 at least partially against the main body 110 and/or the body of the animal 10.

The handle 150 may be disposed on at least a portion of the main body 110. The handle 150 may facilitate gripping thereof. As such, the handle 150 may be used to grasp the main body 110 to hold and/or secure the animal 10.

Therefore, the anti-pulling animal harness 100 may provide a safer walking experience for a user due to preventing the animal 10 from pulling. Also, the anti-pulling animal harness 100 may create a controlled walking experience by increasing control over the animal 10 while wearing it.

The present general inventive concept may include an anti-pulling animal harness 100, including a main body 110 to be worn on a body of an animal 10, a leg wrap 120 connected to the main body 110 to be worn on front legs of the animal 10, and a plurality of leashes 130 connected to the main body 110 and the leg wrap 120 to control movement of the leg wrap 120.

The leg wrap 120 may include a plurality of wrap bodies 121 to receive the front legs of the animal 10 therethrough, and a plurality of leg leash connectors 122 disposed on at least a portion of at least one of the plurality of wrap bodies 121 to connect to at least one of the plurality of leashes 130.

The anti-pulling animal harness 100 may further include a plurality of body leash connectors 140 disposed on at least a portion of the main body 110 to receive at least one of the plurality of leashes 130 therethrough.

The plurality of body leash connectors 140 dispose the plurality of leashes 130 against the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An anti-pulling animal harness, comprising:
a main body to be worn on a body of an animal;
a leg wrap connected to the main body to be worn on front legs of the animal; and
a plurality of leashes connected to the main body and the leg wrap to control movement of the leg wrap.

2. The anti-pulling animal harness of claim 1, wherein the leg wrap comprises:
a plurality of wrap bodies to receive the front legs of the animal therethrough; and
a plurality of leg leash connectors disposed on at least a portion of at least one of the plurality of wrap bodies to connect to at least one of the plurality of leashes.

3. The anti-pulling animal harness of claim 1, further comprising:
a plurality of body leash connectors disposed on at least a portion of the main body to receive at least one of the plurality of leashes therethrough.

4. The anti-pulling animal harness of claim 3, wherein the plurality of body leash connectors dispose the plurality of leashes against the main body.
